(19) United States
(12) Patent Application Publication
(10) Pub. No.: US 2008/0278638 A1
(43) Pub. Date: Nov. 13, 2008

(54) Liquid crystal television and display device

(75) Inventors: Nobuo NAKAJIMA, Tokyo (JP); Koichi GYODA, Tokyo (JP); Eiji SHIBUYA, Kobe-shi (JP); Takehiro ONOMATSU, Osaka (JP); Hideto YOSHIMURA, Osaka (JP)

Correspondence Address: Yokoi & Co., U.S.A., Inc., 13700 Marina Pointe Drive #723, Marina Del Rey, CA, 90292, US

(73) Assignees: THE UNIVERSITY OF ELECTRO-COMMUNICATIONS, Tokyo (JP); Funai Electric Co., Ltd., Osaka (JP)

(21) Appl. No.: 12/151,225

(22) Filed: May 5, 2008

(30) Foreign Application Priority Data
May 8, 2007 (JP) JP2007-123454

(51) Int. Cl. G09G 3/36; G09G 3/20; H04N 9/00

(52) U.S. Cl. 348/794; 345/204

(57) ABSTRACT

The present invention discloses a display device, comprising: a display with deviated directivity in an orientation angle offering good viewability, a casing that holds the display and is placed at a plurality of angles, a direction sensor detecting a direction of placement of the casing, a video processing circuit for outputting a video to the display, and a switching circuit for switching an angle of the video output from the video processing circuit based on the direction of the placement detected by the direction sensor.

### CROSS-REFERENCES TO RELATED APPLICATIONS

The present application is related to the Japanese Patent Application No. 2007-123454, filed May 8, 2007, the entire disclosure of which is expressly incorporated by reference herein.

### BACKGROUND OF THE INVENTION

(1) Field of the Invention

The present invention relates to a liquid crystal television and a display device, and more particularly to a liquid crystal television equipped with a liquid crystal display having directivity in the direction offering a good viewability, and a display device.

(2) Description of the Related Art

The liquid crystal display, which has anisotropy in the structure and orientation of liquid crystal molecules, inevitably gives rise to directivity in the angle offering a good view. Thanks to this, it depended on an audience's position toward the liquid crystal display whether or not they could command a good view of a video displayed on it. In the case of a portable liquid crystal television, in particular, in which the audience can place it on any place and watch it at any angle, they have been more and more discontented with the directivity of the liquid crystal display.

In an attempt to cope with such problem, there has been proposed a device in which a liquid crystal panel is rotatably mounted on a casing and further an operating button is provided for the rotation of the angle of an image displayed on the panel (see JP-A No. H5-56424).

Such arrangement, in which an audience can rotate an image together with the liquid crystal panel when they find they have a poor view of the image, made it possible to improve viewability of the panel while maintaining the direction of the image toward them.

### BRIEF SUMMARY OF THE INVENTION

The present invention include a display device, comprising: a display with deviated directivity in an orientation angle offering good viewability, a casing that holds the display and is placed at a plurality of angles, a direction sensor detecting a direction of placement of the casing, a video processing circuit for outputting a video to the display, and a switching circuit for switching an angle of the video output from the video processing circuit based on the direction of the placement detected by the direction sensor.

These and other features, aspects, and advantages of invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and the drawings are to be used not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is a perspective view of a liquid crystal television.

FIG. 2 is a side view of a liquid crystal television.

FIG. 3 is an internal block diagram of a liquid crystal television.

FIG. 4 is a flowchart of switching processing.

### DETAILED DESCRIPTION OF THE INVENTION

One embodiment of the present invention will be described in the order as follows:

A. First embodiment

B. Modified example

### A. First Embodiment

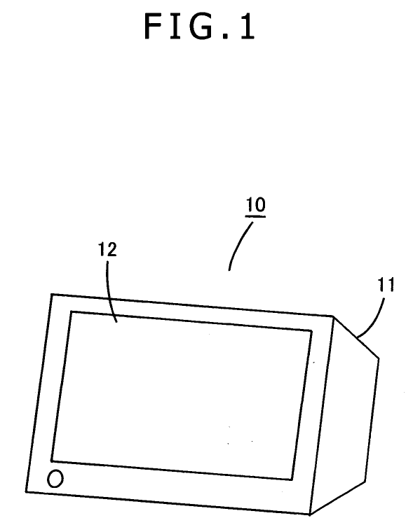

FIG. 1 illustrates a liquid crystal television as a display device according to one embodiment of the present invention as viewed in perspective. In the figure, the liquid crystal television 10, which is a small-sized television for stationary use, has a casing 11 holding a liquid crystal display 12 at its front. The television 10 is placed with the casing 11 on the horizontal plane of a floor, desk and the like. The casing 11 is formed so small as to be portable.

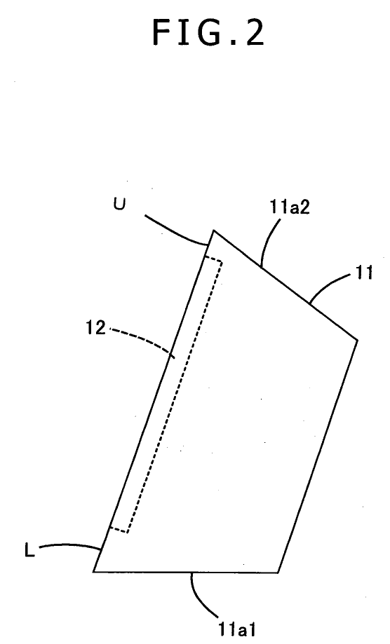

FIG. 2 illustrates the casing 11 as viewed from the side. In the figure, the casing 11 is formed to have a configuration in the shape of a substantially isosceles trapezoid, holding the liquid crystal display 12 on the rectangular surface of the lower base side thereof. The casing 11 is provided with slopes 11a1 and 11a2 of the equal inclined angle, being placed in such a way that either of them comes in contact with the horizontal plane of a floor, table and the like. Since the slopes 11a1 and 11a2 have the equal inclined angle, it is possible to place the casing 11 in such a way that the inclined angle of the liquid crystal display 12 is kept constant no matter which slope may be put down to place the casing 11.

The liquid crystal display 12 is equipped with a backlight and a liquid crystal (LCD) panel, making it possible for a color video to be reproduced through the selective transmission of the light sent out from the backlight through RGB channels of each pixel forming the liquid crystal panel. Each pixel is able selectively to shield the backlight through inclination of liquid crystal molecules based on video signals. These liquid crystal molecules, which have a slant to the display surface of the liquid crystal panel, make it hard for an audience to view a displayed image at an angle unfavorable for shielding, giving rise to directivity in the angle offering good viewability.

Suppose that the upper part of the casing 11 in FIG. 2 is indicated as an upper standard portion U and the lower part of the casing 11 in FIG. 2 is indicated as a lower standard portion L. In the present embodiment, the liquid crystal display 12 is held at an angle offering better viewability when users view the display 12 from the side of the upper standard portion U and poor viewability when the users view the display 12 from the side of the lower standard portion L. In another words, the present embodiment is designed to secure users' viewability from above at the time when the liquid crystal television 10 is placed on the floor through deliberate upward deviation of the angle offering good viewability. The liquid crystal television 10, however, which is of portable type, is sometimes used, for example, on the shelf or desk. In such a case, the users' eye level lowers, causing the users to view the display 12 from the side of its lower standard portion L that is poor in viewability.

To overcome such inconvenience, the casing 11 may be turned upside down to place it on the shelf or desk, thus making it possible for the users to view the liquid crystal display 12 from the side of its upper standard portion U that is excellent in viewability even if the users' eye level lowers. Thanks to the slopes 11a1 and 11a2 of the equal inclined angle, the casing 11 may be turned over in such a way that the slope 11a2 comes in contact with the surface of placement.

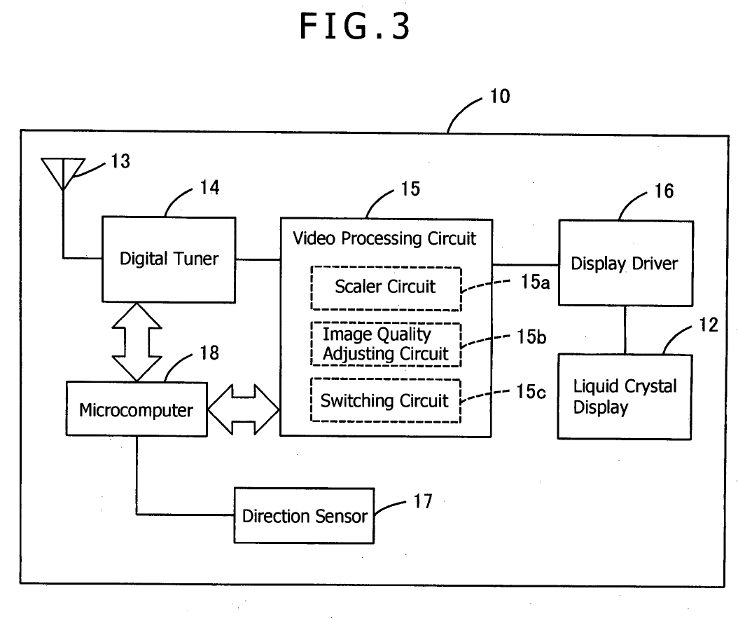

FIG. 3 illustrates the internal formation of the liquid crystal television 10. In the figure, the liquid crystal television 10 is equipped with a microcomputer 18, an antenna 13, a digital tuner 14, a video processing circuit 15, a display driver 16, and a direction sensor 17. The microcomputer 18, which contains not-shown CPU, RAM and ROM, while expanding a control program read out from ROM on RAM, runs it through arithmetic processing in CPU thereby to execute processing to be hereinafter described. It will be preferable for a small-sized antenna 13 to be incorporated in the liquid crystal television 10 in order to enhance its portability.

The antenna 13 is the one capable of receiving UHF range, through which terrestrial digital broadcasting is carried, and it sends out received airwaves to a digital tuner 14. The digital tuner 14 is equipped with a channel selection circuit for setting a desired wave band to be received, a demodulation circuit, a detection circuit, a decoder circuit, a demultiplexing circuit and the like, and it puts out a video signal in the form of digital broadcasting data to the video processing circuit 15. The video processing circuit 15 is equipped with a scaler circuit 15a and image quality adjusting circuit 15b for adjusting the size and image quality of a video through digital signal processing. Furthermore, the video processing circuit 15 is equipped with a switching circuit 15c for switching the direction of a video. The display driver 16 converts a video signal put out from the switching circuit 15c into a driving signal capable of driving the liquid crystal display 12 before putting it out.

As for the direction sensor 17, which is an inclination sensor of one axis having direction along the vertical direction of the casing 11, a mercury sensor or a pendulum-type sensor may be used. The direction sensor 17 makes it possible to detect whether the casing 11 is placed with its upper standard portion U up or the casing 11 is placed with its upper standard portion U down. The direction sensor 17 directs the microcomputer 18 to put out a detection signal of high level (1) when the casing 11 is placed with its upper standard portion U down and except for that case the sensor 17 directs the microcomputer 18 to put out a detection signal of low level (0).

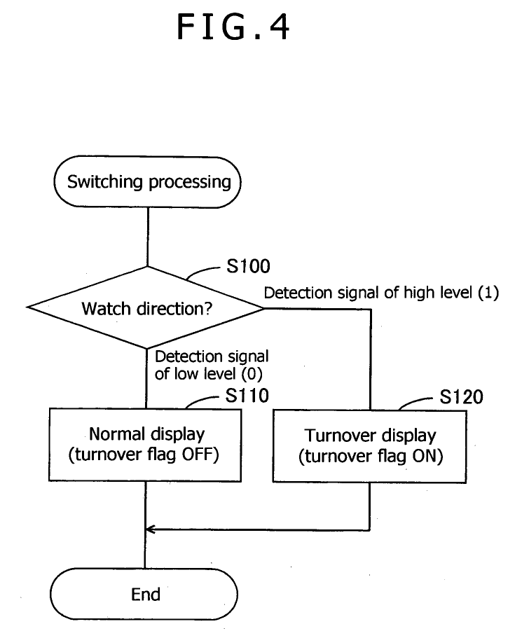

FIG. 4 illustrates a flow of switching processing executed by the microcomputer 18. This switching processing is kept on periodically throughout the time when the power of the liquid crystal television 10 is on. At step 100, the microcomputer 18 is watching detection signals input into it from the direction sensor 17, and performs normal display processing at step 110 when a detection signal of low level (0) is input. On the other hand, when a detection signal of high level (1) is input, the microcomputer 18 performs turnover display processing at step 120. In the turnover display processing, the microcomputer 18 sets a turnover flag for turning an image over to the switching circuit 15c in the video processing circuit 15. Thereby a processing to turn over each frame data forming a video 180 degrees is performed in the switching circuit 15c, so that a video turned upside down comes to be displayed on the liquid crystal display 12. On the other hand, the turnover flag set to the switching circuit 15c will be canceled in the normal display processing in which a detection signal of low level (0) is input.

Such periodic execution of the switching processing (switching measures) as described above makes it possible to watch in which direction the casing 11 is placed all the time and switch to turning a video upside down 180 degrees only when the casing 11 is placed with its upper standard portion U down. This makes it possible for users to watch the liquid crystal television 10 in such a way as follows: First, the users will place the portable liquid crystal television 10 on a variety of places according to their intention. If the liquid crystal television 10 is of a noise-free digital type, it will be placed on a variety of locations. Furthermore, it will be freely placed, for example, in a bathroom by making the casing 11 waterproof. Then the users will place the casing 11 with its upper standard portion U either up or down by turning it over for a direction offering better viewability because the liquid crystal display 12 has directivity in the direction offering good viewability. For instance, in the case of having a shower in the bathroom, where the users will look down from a higher position, the casing 11 will be placed with its upper standard portion U up, while in the case of soaking in a bathtub, where they will look up from a lower position, the casing 11 will be placed with its upper standard portion U down.

In this instance too, the abovementioned switching processing is all the time on and when the upper standard portion U is in an upper position, a video is displayed as usual in such a way that its upper part is on the side of the upper standard portion U upon detection by the detection sensor 17. On the other hand, when the upper standard portion U is in a lower position, the video is displayed in such a way that its lower part is on the side of the upper standard portion U upon detection by the detection sensor 17. In either case, the video is so switched as to direct its upper part toward the actual upper position. That is to say, users have only to turn over the casing 11 in the direction offering them a good view because a video will follow in the right direction. Thus the liquid crystal television 10 will be extremely easy to use.

### B. Modified Example

Although there has been disclosed a device for turning a video upside down in the abovementioned embodiment, it may be so modified as to detect a rotational direction of the casing 11 every 90 degrees using a direction sensor 17 with more than two axes and rotate a video every 90 degrees. For instance, it is possible to construct a liquid crystal television that may be rotated every 90 degrees for placement by forming the casing 11 into the shape of a isosceles trapezoid not only in side view, but also in top view. If the television is rotated 90 degrees for placement, a video may be rotated 90 degrees in the opposite direction through the direction of the switching circuit 15c to view the video in the normal direction. Although rotation of the casing 11 at an interval of 90 degrees may also give rise to a problem of aspect ratio with regard to the liquid crystal display 12, adjustments on the ratio at the scaler circuit 15a or addition of black curtains will overcome the problem. Although so far there have been shown some examples of the present invention applied to a liquid crystal display that is remarkable in directivity, it goes without saying that the present invention may be applied to other displays such as a plasma display and a rear projection display.

To this end, one aspect of the invention has an arrangement wherein a display device equipped with a display comprises a casing holding the display with deviated directivity in the direction offering good viewability and further capable of being placed at a plurality of angles, a direction sensor capable of detecting the direction the casing is placed in, a video processing circuit for putting out a video to the display, and means for switching the angle of the video put out from the video processing circuit upon detection of the direction of placement by the direction sensor.

In one aspect of the invention as described above, the casing holds a display in such a state that its directivity in the direction offering good viewability deviates. In a display made of liquid crystal, for example, it is inevitable for directivity in the direction offering good viewability to occur and the casing does hold the display of which directivity deviates in a certain direction. In another words, the display is held on the casing in such a way that deviation in viewability occurs so that an audience may command a good view of a video on the display when looking down from above and cannot when looking up from below. The casing may also be placed at a plurality of angles. When users find they cannot command a good view of the display at an angle the casing is placed, they may change the angle to improve viewability. The direction sensor detects the direction the casing is placed in and upon the result of detection, the switching means directs the video processing circuit, which puts out a video to the display, to switch the angle of a video. Through this process, the circuit can recognize the change in the direction the casing is placed in, and can accordingly rotate the video in an appropriate direction. Since there is no need for the users to operate the rotational direction of a video, the display device in this invention is easy to use.

According to one mode of the present invention, the invention also has an arrangement wherein the display device further comprises a digital tuner for receiving digital television broadcasting and putting out broadcasting data to the video processing circuit. Since digital television broadcasting, which is resistant to noise, is suitable for a portable display device, such device will be placed on a variety of places. In such a case, where the position of the display toward users' eyes varies, the direction the casing is placed in will be changed for an angle offering a better viewability according to the position of placement. In the present invention, however, a video, which is rotated in an appropriate direction upon detection of the direction of placement, may be viewed at a constant angle.

According to another mode of the present invention, the invention further has an arrangement wherein the casing has a configuration in the shape of a substantially isosceles trapezoid in side view with the display held on the lower base side thereof. When viewed from the side, the casing takes the shape of a substantially isosceles trapezoid with the display held on the lower base side thereof. Since the casing has two slopes with the equal inclined angle each other, it may be placed on the surface of placement with either of its slopes down, which means that it may be placed at a plurality of angles. By placing the casing with its slopes down, the display mounted on the lower base side of the casing may be obliquely positioned, thus making it easy to command a good view of the display when the casing is placed, for example, on the floor.

The present invention may also be realized through a liquid crystal television in which the above-described arrangement is made still more concrete. As its concrete example, another aspect of the present invention has an arrangement wherein a liquid crystal television equipped with a liquid crystal display comprises a casing of stationary type holding the liquid crystal display with deviated directivity in the direction offering good viewability, further having a configuration in the shape of a substantially isosceles trapezoid in side view with the display held on the lower base side thereof, and capable of being turned upside down for placement at either angle, a direction sensor capable of detecting the vertical direction the casing is placed in, a video processing circuit for putting out a video to the liquid crystal display, a digital tuner for receiving digital television broadcasting and putting out broadcasting data to the video processing circuit, and means for switching to turning or not turning the angle of the video put out from the video processing circuit 180 degrees upon detection of the vertical direction of placement by the direction sensor.

Although the invention has been described in considerable detail in language specific to structural features or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It is to be understood that the phraseology and terminology employed herein, as well as the abstract, are for the purpose of description and should not be regarded as limiting.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A display device, comprising:
a display with deviated directivity in an orientation angle offering good viewability,
a casing that holds the display and is placed at a plurality of angles,
a direction sensor detecting a direction of placement of the casing,
a video processing circuit for outputting a video to the display, and
a switching circuit for switching an angle of the video output from the video processing circuit based on the direction of the placement detected by the direction sensor.

2. The display device as set forth claim 1, further comprising a digital tuner for receiving digital television broadcasting and putting out broadcasting data to the video processing circuit.

3. The display device as set forth claim 1, wherein the casing formed in a substantially isosceles trapezoid shape in side view whose lower base side holds the display.

4. A display device, comprising:
a liquid crystal display with deviated directivity in an orientation angle offering good viewability,
a casing formed in a substantially isosceles trapezoid shape in side view where a lower base side holds the liquid crystal display and is capable of being turned upside down for placement at either angle,
a direction sensor detecting a direction of the placement of the casing,
a video processing circuit for outputting a video to the liquid crystal display,
a digital tuner for receiving digital television broadcasting, and outputting broadcasting data to the video processing circuit, and
a switching circuit for turning an angle of the video output from the video processing circuit at 180 degrees based on the direction of the placement detected by the direction sensor.
